(19) United States
(12) Patent Application Publication
(10) Pub. No.: US 2026/0229405 A1
(43) Pub. Date: Aug. 6, 2026

(54) COMPOSITE ELECTRONIC COMPONENT

(71) Applicant: SAMSUNG ELECTRO-MECHANICS CO., LTD., Suwon-si (KR)

(72) Inventors: Da Jeong HAN, Suwon-si (KR); Beom Joon CHO, Suwon-si (KR)

(73) Assignee: SAMSUNG ELECTRO-MECHANICS CO., LTD., Suwon-si (KR)

(21) Appl. No.: 19/397,486

(22) Filed: Nov. 21, 2025

(30) Foreign Application Priority Data
Feb. 5, 2025 (KR) 10-2025-0014384

(51) Int. Cl. H01G 2/06; H01G 4/224; H01G 4/232; H01G 4/248; H01G 4/30

(52) U.S. Cl. CPC H01G 2/06; H01G 4/224; H01G 4/232; H01G 4/248; H01G 4/30

(57) ABSTRACT

A composite electronic component includes a multilayer electronic component having a body with a dielectric layer and internal electrodes arranged alternately in a thickness direction. The body has first and second surfaces opposing each other in the thickness direction, third and fourth surfaces opposing each other in a length direction, and fifth and sixth surfaces opposing each other in a width direction. An external electrode includes a connection portion on the third and fourth surfaces and a band portion extending toward the first and second surfaces. A metal frame is positioned on the external electrode, and a non-conductive adhesive is provided between the external electrode and the metal frame. The total content of the adhesive is controlled to be greater than 0.6 mg and less than 0.9 mg to improve mounting reliability and reduce acoustic noise.

### CROSS-REFERENCE TO RELATED APPLICATION(S)

This application claims benefit of priority to Korean Patent Application No. 10-2025-0014384 filed on Feb. 5, 2025 in the Korean Intellectual Property Office, the disclosure of which is incorporated herein by reference in its entirety.

### TECHNICAL FIELD

The present disclosure relates to a composite electronic component.

A multilayer ceramic capacitor (MLCC), a type of multilayer electronic component applied to composite electronic components, is a chip-type capacitor mounted on the printed circuit boards of various types of electronic products, such as imaging devices including liquid crystal displays (LCDs) and plasma display panels (PDPs), computers, smartphones, cell phones, and the like, to be charged with electricity and discharged.

As multilayer ceramic capacitors have recently expanded in terms of use thereof into automotive electrical components, high reliability is required even under diverse environmental conditions. To achieve this, metal frames may be bonded to multilayer ceramic capacitors or multilayer ceramic capacitors may be coated with other materials to minimize thermal and mechanical stress or moisture infiltration paths to improve reliability, including electrical and moisture resistance, and also reduce acoustic noise. Furthermore, the application of metal frames allows the expansion of a plurality of chip stacks, thereby facilitating the implementation of high-capacity capacitors.

However, if the metal frame is manufactured or attached in a manner that deviates from the specified substrate specifications, mounting may not be properly performed. Even if mounted, the metal frame may be separated or broken due to external vibrations or physical impacts under actual use conditions.

### SUMMARY

An aspect of the present disclosure is to provide a composite electronic component having excellent substrate mounting performance.

Another aspect of the present disclosure is to provide a composite electronic component having reduced acoustic noise.

Another aspect of the present disclosure is to provide a composite electronic component having excellent moisture resistance reliability.

However, the problems to be solved by the present disclosure are not limited to the above-described contents and will be more easily understood in the course of describing specific exemplary embodiments of the present disclosure.

According to an aspect of the present disclosure, a composite electronic component includes: a multilayer electronic component including a body including a dielectric layer and internal electrodes alternately disposed with the dielectric layer in a thickness direction and including first and second surfaces opposing each other in the thickness direction, third and fourth surfaces connected to the first and second surfaces and opposing each other in the length direction, and fifth and sixth surfaces connected to the first to fourth surfaces and opposing each other in a width direction and an external electrode including a connection portion disposed on the third and fourth surfaces and a band portion extending from the connection portion to portions of the first and second surfaces; a metal frame disposed on the external electrode; and a non-conductive adhesive disposed between the external electrode and the metal frame, wherein a total content of the non-conductive adhesive is more than 0.6 mg and less than 0.9 mg.

According to another aspect of the present disclosure, a composite electronic component includes: a multilayer electronic component including a body including a dielectric layer and internal electrodes alternately arranged with the dielectric layer in a thickness direction and including first and second surfaces opposing each other in the thickness direction, third and fourth surfaces connected to the first and second surfaces and opposing each other in the length direction, and fifth and sixth surfaces connected to the first to fourth surfaces and opposing each other in a width direction, an external electrode including a connection portion disposed on the third and fourth surfaces and a band portion extending from the connection portion to portions of the first and second surfaces, and a protective layer disposed on at least one of the body and the external electrode; a metal frame disposed on the external electrode; and a non-conductive adhesive disposed between the external electrode and the metal frame, wherein the metal frame is disposed on the connection portion and the band portion disposed on the first surface, with the non-conductive adhesive interposed therebetween.

### BRIEF DESCRIPTION OF DRAWINGS

The other aspects, features, and advantages of the present disclosure will be more clearly understood from the following detailed description, taken in conjunction with the accompanying drawings, in which:

FIG. 1 is a perspective view schematically illustrating a composite electronic component according to an exemplary embodiment of the present disclosure;

FIG. 2 is a schematic cross-sectional view taken along line I-I′ of FIG. 1;

FIG. 3 is a schematic cross-sectional view taken along line II-II′ of FIG. 1;

FIG. 4 is a perspective view schematically illustrating a metal frame and a non-conductive adhesive; and

FIG. 5 is a graph schematically illustrating acoustic noise values according to adhesive content.

### DETAILED DESCRIPTION

Hereinafter, exemplary embodiments of the present disclosure will be described in detail with reference to the accompanying drawings. The inventive concept may, however, be exemplified in many different forms and should not be construed as being limited to the specific exemplary embodiments set forth herein. Rather, these exemplary embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrelevant of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

In the drawings, the Z direction may be defined as a thickness direction or a first direction, the X direction as a length direction or a second direction, and the Y direction as a width direction or a third direction. Furthermore, a stacking direction may be either the thickness direction or the width direction. Furthermore, in the present disclosure, thickness may refer to the size in the thickness direction (the first direction), length may refer to the size in the length direction (the second direction), and width may refer to the size in the width direction (the third direction).

### Composite Electronic Components

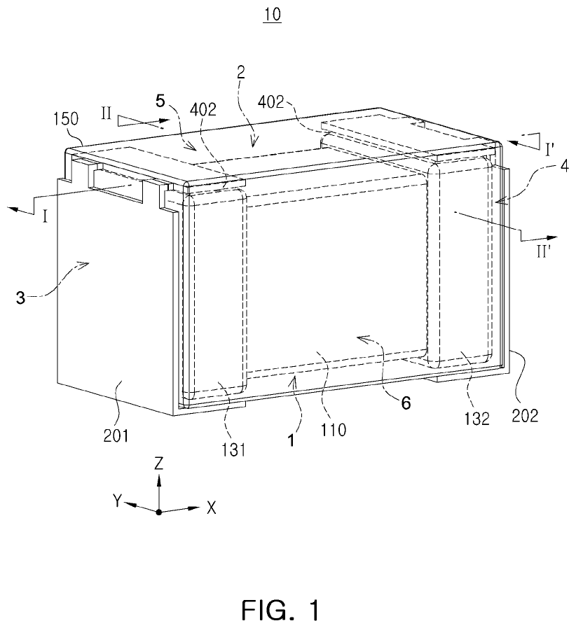

FIG. 1 is a perspective view schematically illustrating a composite electronic component according to an exemplary embodiment of the present disclosure.

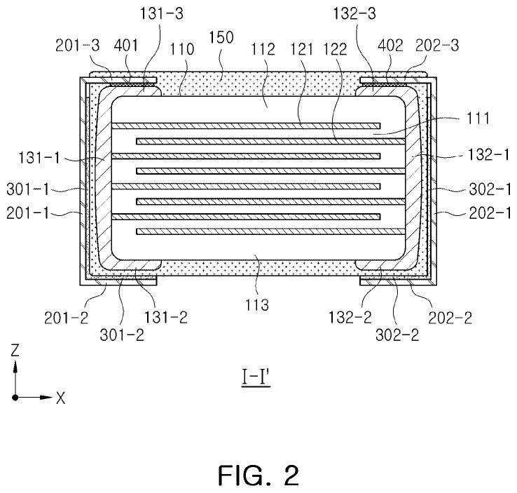

FIG. 2 is a schematic cross-sectional view taken along line I-I′ of FIG. 1.

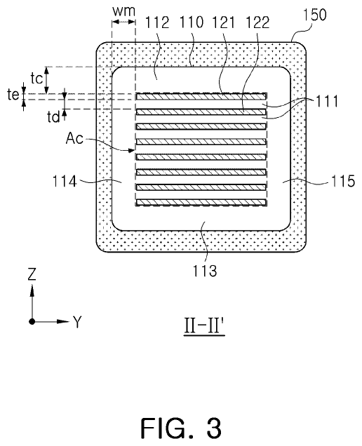

FIG. 3 is a schematic cross-sectional view taken along line II-II′ of FIG. 1.

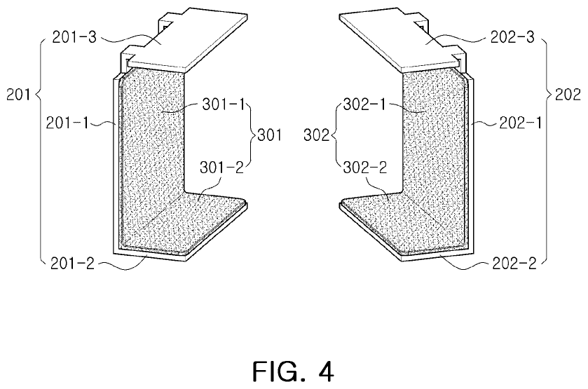

FIG. 4 is a perspective view schematically illustrating a metal frame and a non-conductive adhesive.

Hereinafter, a composite electronic component according to an exemplary embodiment of the present disclosure will be described in detail with reference to FIGS. 1 through 4. While a multilayer ceramic capacitor is described as an example of a multilayer electronic component, which is a component of the composite electronic component, the present disclosure may also be applied to various electronic products utilizing dielectric compositions, such as inductors, piezoelectric devices, varistors, or thermistors.

A composite electronic component 10 according to an exemplary embodiment of the present disclosure includes a multilayer electronic component 100 including a body 110 including a dielectric layer 111 and internal electrodes 121 and 122 alternately arranged with the dielectric layer 111 in the thickness direction and including first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth surfaces 1, 2, 3, and 4 and opposing each other in the width direction and external electrodes 131 and 132 including connection portions 131-1 and 132-1 disposed on the third and fourth surfaces 3 and 4 and band portions 131-2, 132-2, 131-3, and 132-3 extending from the connection portions 131-1 and 132-1 to portions of the first and second surfaces 1 and 2; metal frames 201 and 202 disposed on the external electrodes 131 and 132; and non-conductive adhesives 301 and 302 disposed between the external electrodes 131 and 132 and the metal frames 201 and 202, wherein the total content of the non-conductive adhesives 301 and 302 may be greater than 0.6 mg and less than 0.9 mg.

According to another exemplary embodiment of the present disclosure, a composite electronic component 10 includes a multilayer electronic component 100 including a body 110 including a dielectric layer 111 and internal electrodes 121 and 122 alternately arranged with the dielectric layer 111 in the thickness direction and including first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth surfaces 1, 2, 3, and 4 and opposing each other in the width direction, external electrodes 131 and 132 including connection portions 131-1 and 132-1 disposed on the third and fourth surfaces 3 and 4 and band portions 131-2, 132-2, 131-3, and 132-3 extending from the connection portions 131-1 and 132-1 to portions of the first and second surfaces 1 and 2, and a protective layer 150 disposed on at least one of the body 110 and the external electrodes 131 and 132; metal frames 201 and 202 disposed on the external electrodes 131 and 132; and non-conductive adhesives 301 and 302 disposed between the external electrodes 131 and 132 and the metal frames 201 and 202, wherein the metal frames 201 and 202 may be disposed on the connection portions 131-1 and 132-1 and the band portions 131-2 and 132-2 disposed on the first surface with the non-conductive adhesives 301 and 302 interposed therebetween.

The body 110 may include the dielectric layer 111 and the internal electrodes 121 and 122 being alternately stacked.

More specifically, the body 110 may include a capacitance forming portion Ac forming capacitance, including the first internal electrode 121 and the second internal electrode 122 arranged inside the body 110 and alternately arranged to face each other with the dielectric layer 111 interposed therebetween.

Although a specific shape of the body 110 is not particularly limited, as shown, the body 110 may have a hexahedral shape or a shape similar thereto. Due to the shrinkage of ceramic particles included in the body 110 during a sintering process, the body 110 may not have a perfectly straight hexahedral shape but may have a substantially hexahedral shape.

The body 110 may have first and second surfaces 1 and 2 opposing each other in the thickness direction, third and fourth surfaces connected to the first and second surfaces 1 and 2 and opposing each other in the length direction, and fifth and sixth surfaces connected to the first to fourth surfaces 1, 2, 3, and 4 and opposing each other in the width direction.

The plurality of dielectric layers 111 forming the body 110 are in a sintered state, and adjacent dielectric layers 111 may be integrated such that it may be difficult to identify a boundary therebetween without using a scanning electron microscope (SEM).

A material for forming the dielectric layer 111 is not limited as long as sufficient capacitance may be obtained. In general, perovskite (ABO₃)-based materials may be used, and for example, a barium titanate-based material, a lead composite perovskite-based material, or a strontium titanate-based material may be used. The barium titanate-based material may include a BaTiO₃-based ceramic particles, and the ceramic particles may include BaTiO₃ and (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1) in which Ca, Zr, and the like are partially dissolved in BaTiO₃.

In addition, as a material for forming the dielectric layer 111, various ceramic additives, organic solvents, binders, dispersants, etc. may be added to powder particles, such as barium titanate (BaTiO₃), according to purposes of the present disclosure.

Meanwhile, to be distinguished from the dielectric layer included in the cover portions 112 and 113 and side margin portions 114 and 115 described below, the dielectric layer included in the capacitance forming portion Ac may be defined as a first dielectric layer, the dielectric layer included in the cover portions 112 and 113 may be defined as a second dielectric layer, and the dielectric layer included in the side margin portions 114 and 115 may be defined as a third dielectric layer. Here, the first to third dielectric layers are not limited to the same material, nor are they limited to different materials.

Furthermore, since the first to third dielectric layers may be formed using a dielectric material, such as barium titanate (BaTiO₃), they may include a dielectric microstructure after sintering. The dielectric microstructure may include a plurality of grains, grain boundaries arranged between adjacent grains, and a triple point disposed at a point at which three or more grain boundaries meet, and may include a plurality of grains, a plurality of grain boundaries, and a plurality of triple points.

A thickness td of the dielectric layer 111 may not be particularly limited.

To ensure reliability of the multilayer electronic component 100 in high-voltage environments, the thickness td of the dielectric layer 111 may be 10.0 μm or less, 8.0 μm or less, 7.0 μm or less, 6.0 μm or less, or 5.0 μm or less. Furthermore, to achieve miniaturization and high capacity of the multilayer electronic component 100, the thickness td of the dielectric layer 111 may be 3.0 μm or less. To facilitate ultra-miniaturization and high capacity, the thickness td of the dielectric layer 111 may be 1.0 μm or less, preferably 0.6 μm or less, and more preferably 0.4 μm or less.

Here, the thickness td of the dielectric layer 111 may refer to the thickness td of the dielectric layer 111 disposed between the first and second internal electrodes 121 and 122.

At this time, the thickness td of the dielectric layer 111 may refer to the thickness td of any one of the plurality of dielectric layers 111 or may refer to the thickness td of each of all the dielectric layers 111.

Furthermore, the thickness td of the dielectric layer 111 may refer to an average thickness td of one dielectric layer 111, an average thickness td of each of the plurality of dielectric layers 111, or an average thickness td of the plurality of dielectric layers 111.

The average thickness td of the dielectric layer 111 may be measured by scanning an image of a length and thickness-wise cross-section of the body 110 using a scanning electron microscope (SEM) at 10,000× magnification. More specifically, the average thickness td of one dielectric layer 111 may be an average value calculated by measuring thicknesses at five equally spaced points of one dielectric layer 111 in the length direction in the scanned image. These five equally spaced points may be designated in the capacitance forming portion Ac. Furthermore, by extending this average measurement to three dielectric layers 111 and measuring the average value, the average thickness td of a plurality of dielectric layers 111 may be more generalized.

The internal electrodes 121 and 122 may be alternately stacked with the dielectric layers 111.

The internal electrodes 121 and 122 may include the first internal electrode 121 and the second internal electrode 122. The first and second internal electrodes 121 and 122 may be alternately arranged to face each other with the dielectric layer 111 forming the body 110 interposed therebetween and may be exposed to the third and fourth surfaces 3 and 4 of the body 110, respectively.

More specifically, the first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third surface 3 of the body 110 and connected to the first internal electrode 121, and a second external electrode 132 may be disposed on the fourth surface 4 of the body 110 and connected to the second internal electrode 122.

That is, the first internal electrode 121 may be connected to the first external electrode 131 without being connected to the second external electrode 132, and the second internal electrode 122 may be connected to the second external electrode 132 without being connected to the first external electrode 131. In this case, the first and second internal electrodes 121 and 122 may be electrically separated from each other by the dielectric layer 111 disposed therebetween.

Meanwhile, the body 110 may be formed by alternately stacking a first ceramic green sheet on which a first internal electrode paste, which is to become the first internal electrode 121, is printed and a second ceramic green sheet on which a second internal electrode paste, which is to become the second internal electrode 122, is printed and then sintering the sheets.

The printing method for the conductive paste for the internal electrodes may be a screen printing method or gravure printing method, but the present disclosure is not limited thereto.

The material forming the internal electrodes 121 and 122 is not particularly limited, and any material with excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

Meanwhile, a thickness the of the internal electrodes 121 and 122 may not be particularly limited. Hereinafter, the description of the thickness the of the internal electrodes 121 and 122 may refer to the thickness the of each of the first internal electrode 121 and the second internal electrode 122.

To ensure reliability of the multilayer electronic component 100 in high-voltage environments, the thickness the of the internal electrodes 121 and 122 may be 3.0 μm or less. Furthermore, to achieve miniaturization and high capacity of the multilayer electronic component 100, the thickness the of the internal electrodes 121 and 122 may be 1.0 μm or less. To achieve ultra-miniaturization and high capacity more easily, the thickness the of the internal electrodes 121 and 122 may be 0.6 μm or less, and more preferably 0.4 μm or less.

At this time, the thickness the of the internal electrodes 121 and 122 may be a concept including the thickness the of at least one of the plurality of internal electrodes 121 and 122 or may be a concept including the thickness the of all internal electrodes 121 and 122.

At this time, the thickness the of the internal electrodes 121 and 122 may be a concept including the thickness the of at least one of the plurality of internal electrodes 121 and 122 or may be a concept including the thickness the of each of the plurality of internal electrodes 121 and 122.

In addition, the thickness the of the internal electrodes 121 and 122 may refer to an average thickness the of a single internal electrodes 121 or 122, an average thickness the of each of a plurality of internal electrodes 121 and 122, or an average thickness the of a plurality of internal electrodes 121 and 122.

The average thickness the of the internal electrodes 121 and 122 may be measured by scanning an image of a length and thickness-wise cross-section of the body 110 using a scanning electron microscope (SEM) at 10,000× magnification. More specifically, the average thickness the of one internal electrode 121 or 122 may be an average value calculated by measuring the thickness of one internal electrode at five equally spaced points in the scanned image in the length direction. These five equally spaced points may be designated in the capacitance forming portion Ac. Furthermore, by extending this average measurement to three internal electrodes 121 and 122, the average thickness the of a plurality of internal electrodes 121 and 122 may be further generalized.

Meanwhile, in an exemplary embodiment of the present disclosure, the thickness td of at least one of the plurality of dielectric layers 111 and the thickness the of at least one of the plurality of internal electrodes 121 and 122 may satisfy 2×te<td.

In other words, the thickness td of one dielectric layer 111 may be greater than twice the thickness the of one internal electrode 121 or 122. Preferably, the average thickness td of the plurality of dielectric layers 111 may be greater than twice the average thickness the of the plurality of internal electrodes 121 and 122.

In general, reliability issues for high-voltage electrical electronic components due to reduced breakdown voltage (BDV) in high-voltage environments are a major concern.

Therefore, to prevent a reduction in breakdown voltage in high-voltage environments, the average thickness td of the dielectric layer 111 may be increased to be more than twice the average thickness the of the internal electrodes 121 and 122, thereby improving breakdown voltage characteristics.

If the average thickness td of the dielectric layer 111 is twice or less of the average thickness the of the internal electrodes 121 and 122, the breakdown voltage may decrease and a short circuit may occur between the internal electrodes.

Meanwhile, the body 110 may include cover portions 112 and 113 disposed on both end surfaces of the capacitance forming portion Ac in the thickness direction.

Specifically, the body 110 may include a first cover portion 112 disposed on one surface of the capacitance forming portion Ac in the thickness direction and a second cover portion 113 disposed on the other surface of the capacitance forming portion Ac in the thickness direction. More specifically, for example, the body 110 may include the first cover portion 112 disposed below the capacitance forming portion Ac in the thickness direction and the second cover portion 113 disposed above the capacitance forming portion Ac in the thickness direction.

The first cover portion 112 and the second cover portion 113 may be formed by disposing or stacking a single second dielectric layer or two or more second dielectric layers on the upper and lower surfaces of the capacitance forming portion Ac in the thickness direction, respectively and may fundamentally serve to prevent damage to the internal electrodes 121 and 122 due to physical or chemical stress.

The first cover portion 112 and the second cover portion 113 do not include the internal electrodes 121 and 122 and may include the same dielectric material as the first dielectric layer 111 of the capacitance forming portion Ac. That is, the first cover portion 112 and the second cover portion 113 may include a dielectric material, for example, a barium titanate (BaTiO₃)-based dielectric material.

Meanwhile, the thickness tc of the cover portions 112 and 113 may not be particularly limited. Hereinafter, the description of the thickness tc of the cover portions 112 and 113 may refer to the thickness tc of each of the first cover portion 112 and the second cover portion 113.

However, to more easily achieve miniaturization and high capacity of the multilayer electronic component 100, the thickness tc of the cover portions 112 and 113 may be 100 μm or less or 50 μm or less, preferably 30 μm or less, and more preferably 20 μm or less for ultra-small products.

Here, the thickness tc of the cover portions 112 and 113 may refer to the average thickness of the cover portions 112 and 113.

In addition, the average thickness tc of the cover portions 112 and 113 may refer to an average thickness tc of each of the first and second cover portions 112 and 113 or may refer to an average thickness tc of the first and second cover portions 112 and 113.

The average thickness tc of the cover portions 112 and 113 may be measured by scanning an image of a length and thickness-wise cross-section of the body 110 using a scanning electron microscope (SEM) at 10,000× magnification. More specifically, the average thickness tc may refer to an average value calculated by measuring the thicknesses at five equally spaced points in a scanned image of one cover portion 112 or 113 in the length direction.

In addition, the average thickness tc of the cover portions 112 and 113 measured using the aforementioned method may have a value substantially equal to the average thickness of the cover portions 112 and 113 in the cross-section of the body 110 in the width and thickness directions.

Meanwhile, the multilayer electronic component 100 may include side margin portions 114 and 115, which are widthwise end regions of the internal electrodes 121 and 122.

More specifically, the side margin portions 114 and 115 may include a first side margin portion 114 disposed between the internal electrodes 121 and 122 and the fifth surface 5, and a second side margin portion 115 disposed between the internal electrodes 121 and 122 and the sixth surface 6.

As illustrated, the side margin portions 114 and 115 may refer to a region between both widthwise ends of the first and second internal electrodes 121 and 122 and a boundary surface of the body 110, with respect to the width and thickness-wise cross-section of the body 110 s.

The side margin portions 114 and 115 may refer to a region of a ceramic green sheet excluding the internal electrodes 121 and 122, when an internal electrode paste is applied to the ceramic green sheet, except for the regions that will become the side margin portions 114 and 115, applied to the capacitance forming portion Ac.

However, the present disclosure is not limited thereto, and the side margin portions 114 and 115 may be formed by forming the internal electrodes 121 and 122 by applying a conductive paste to the ceramic green sheet applied to the capacitance forming portion Ac, except where the side margin portions 114 and 115 are to be formed, cutting the body 110 so that the internal electrodes 121 and 122 after stacking are exposed to the fifth and sixth surfaces 5 and 6 of the body 110 to suppress a step difference due to the internal electrodes 121 and 122, and then disposing or stacking a single third dielectric layer or two or more third dielectric layers on both widthwise end surfaces of the capacitance forming portion Ac in the width direction.

The side margin portions 114 and 115 may fundamentally serve to prevent damage to the internal electrodes 121 and 122 due to physical or chemical stress.

The first side margin portion 114 and the second side margin portion 115 do not include internal electrodes 121 and 122, may include the same material as the first dielectric layer 111, and may correspond to, for example, a portion of the first dielectric layer 111. That is, the first side margin portion 114 and the second side margin portion 115 may include a dielectric material, for example, a barium titanate (BaTiO₃)-based dielectric material.

Meanwhile, a width wm of the side margin portions 114 and 115 may not be particularly limited. Hereinafter, the description of the width wm of the side margin portions 114 and 115 may refer to the width wm of each of the first side margin portion 114 and the second side margin portion 115.

To easily achieve miniaturization and high capacity of the multilayer electronic component 100, the width wm of the side margin portions 114 and 115 may be 50 μm or less, preferably 30 μm or less, and more preferably 20 μm or less for ultra-small products.

Here, the width wm of the side margin portions 114 and 115 may refer to an average width wm of the side margin portions 114 and 115.

Furthermore, the average width wm of the side margin portions 114 and 115 may refer to the average width wm of each of the first and second side margin portions 114 and 115 or the average width wm of the first and second side margin portions 114 and 115.

The average width wm of the side margin portions 114 and 115 may be measured by scanning an image of a width and thickness-wise cross-section of the body 110 using a scanning electron microscope (SEM) at 10,000× magnification. More specifically, width wm of the side margin portions 114 and 115 may refer to an average value calculated by measuring the widths at five equally spaced points in a scanned image of one side margin portion 114 or 115 in the thickness direction.

In an exemplary embodiment of the present disclosure, although the multilayer electronic component 100 having two external electrodes 131 and 132 is described, the number and shape of the external electrodes 131 and 132 may vary depending on the shape of the internal electrodes 121 and 122 or other purposes.

The external electrodes 131 and 132 may be disposed on the body 110 and connected to the internal electrodes 121 and 122.

More specifically, the external electrodes 131 and 132 may be disposed on the third and fourth surfaces 3 and 4 of the body 110, respectively, and may include first and second external electrodes 131 and 132 connected to the first and second internal electrodes 121 and 122, respectively. That is, the first external electrode 131 may be disposed on the third surface 3 of the body and connected to the first internal electrode 121, and the second external electrode 132 may be disposed on the fourth surface 4 of the body 110 and connected to the second internal electrode 122.

Furthermore, the external electrodes 131 and 132 may extend to and disposed on portions of the first and second surfaces 1 and 2 of the body 110 or may extend to and disposed on portions of the fifth and sixth surfaces 5 and 6 of the body 110. That is, the first external electrode 131 may be disposed on the third surface 3 of the body 110 and portions of the first, second, fifth, and sixth surfaces 1, 2, 5, and 6 of the body 110, and the second external electrode 132 may be disposed on the fourth surface 4 of the body 110 and portions of the first, second, fifth, and sixth surfaces 1, 2, 5, and 6 of the body 110.

Meanwhile, the external electrodes 131 and 132 may include connection portions 131-1 and 132-1 disposed on the third and fourth surfaces 3 and 4 of the body 110, and band portions 131-2, 132-2, 131-3, and 132-3 extending from the connection portions 131-1 and 132-1 to portions of the first and second surfaces 1 and 2 of the body 110.

More specifically, the first external electrode 131 may include a first connection portion 131-1 disposed on the third surface 3 of the body 110 and first band portions 131-2 and 131-3 extending from the first connection portion 131-1 to portions of the first and second surfaces 1 and 2, and the second external electrode 132 may include a second connection portion 132-1 disposed on the fourth surface 4 of the body 110 and second band portions 132-2 and 132-3 extending from the second connection portion 132-1 to portions of the first and second surfaces 1 and 2.

The first band portions 131-2 and 131-3 may include a 1-1-th band portion 131-2 extending from the first connection portion 131-1 to a portion of the first surface 1 and a 1-2-th band portion 131-3 extending from the first connection portion 131-1 to a portion of the second surface 2, and the second band portion 132-2 and 132-3 may include a 2-1-th band portion 132-2 extending from the second connection portion 132-1 to a portion of the first surface 1 and a 2-2-th band portion 132-3 extending from the second connection portion 132-1 to a portion of the second surface 2.

In the present disclosure, unless otherwise specifically contradictory, the descriptions of the band portions 131-2, 131-3, 132-2, and 132-3 may correspond to the descriptions of the 1-1-th band portion 131-2, the 1-2-th band portion 131-3, the 2-1-th band portion 132-2, and the 2-2-th band portion 132-3, respectively.

The external electrodes 131 and 132 may be formed using any material having electrical conductivity, such as metal, and a specific material may be determined by considering electrical characteristics, structural stability, and the like and may include an electrode layer. Furthermore, the electrode layer may have a multilayer structure.

For example, the external electrodes 131 and 132 may include a first electrode layer disposed on the body 110 and a second electrode layer disposed on the first electrode layer, and furthermore, may include a third electrode layer disposed on the second electrode layer.

Here, it may be preferable that the first to third electrode layers correspond to layers distinguished from each other. However, without being limited thereto, the first to third electrode layers may be distinguished according to the manufacturing process order, and at least some of the first to third electrode layers may not be distinguished from each other and may be observed as one layer.

In the present disclosure, “distinguished” may refer to that two layers are distinguished due to physical differences, chemical differences, and/or simple optical differences, and layers may be, but are not limited to, distinguished from each other by the presence or absence of an “interface.” The interface may refer to a surface by which two layers in contact with each other are distinguishable from each other, and may refer to, for example, a state in which two layers are distinguishable through differences in components, such as EDS analysis, using equipment, such as a scanning electron microscope (SEM).

The electrode layer may be formed by transferring a sheet including conductive metal onto the body 110, applying a conductive paste for external electrodes including a conductive metal to the body 110, or dipping the body 110 in a conductive paste for external electrodes including a conductive metal. However, the present disclosure is not limited thereto.

More specifically, the external electrodes 131 and 132 may include a first electrode layer disposed on the body 110 and including a first conductive metal and glass and a second electrode layer disposed on the first electrode layer and including a second conductive metal and resin.

The conductive metals included in the first and second electrode layers may be materials with excellent electrical conductivity. For example, the conductive metals may include one or more selected from the group consisting of nickel (Ni), copper (Cu), palladium (Pd), silver (Ag), gold (Au), platinum (Pt), tin (Sn), tungsten (W), titanium (Ti), and alloys thereof, but are not particularly limited thereto.

Here, the conductive metal included in the first electrode layer may be referred to as a first conductive metal, and the conductive metal included in the second electrode layer may be referred to as a second conductive metal. The first and second conductive metals may be the same or different. If a plurality of conductive metals are included, only some of the plurality of conductive metals may be the same conductive metals, but the present disclosure is not limited thereto.

The glass included in the first electrode layer may serve to enhance bonding to the body 110. Any material enhancing bonding to the body 110 is not particularly limited. The resin included in the second electrode layer may serve to improve flexural strength. Any resin that may be mixed with the second conductive metal to form a paste is not particularly limited. For example, the resin may include an epoxy-based resin.

The first conductive metal included in the first electrode layer may serve to electrically connect to the internal electrodes 121 and 122.

The first conductive metal included in the first electrode layer is not particularly limited as long as it may be electrically connected to the internal electrodes 121 and 122. For example, the first conductive metal may include at least one of nickel (Ni), copper (Cu), palladium (Pd), silver (Ag), gold (Au), platinum (Pt), tin (Sn), tungsten (W), titanium (Ti), and alloys thereof.

The second conductive metal included in the second electrode layer may serve to electrically connect to the first electrode layer.

The second conductive metal included in the second electrode layer is not particularly limited as long as it may be electrically connected to the first electrode layer, and may include at least one of nickel (Ni), copper (Cu), palladium (Pd), silver (Ag), gold (Au), platinum (Pt), tin (Sn), tungsten (W), titanium (Ti), and alloys thereof.

The second conductive metal included in the second electrode layer may include at least one of spherical particles and flake-shaped particles. Specifically, the second conductive metal may include only flake-shaped particles, only spherical particles, or a mixture of flake-shaped and spherical particles.

Here, the spherical particles may include shapes other than perfectly spherical. For example, the spherical particles may include shapes with a dimensional ratio (major axis/minor axis) of 1.45 or less. Flake-shaped particles refer to particles with a flat, elongated shape. For example, the dimension ratio of the major axis to the minor axis may be 1.95 or greater, but is not particularly limited. The dimension of the major and minor axes of the spherical particles and flake-shaped particles may be measured from images obtained by scanning length and thickness-wise cross-sections taken from the widthwise center of the multilayer electronic component using a scanning electron microscope (SEM).

Furthermore, the second electrode layer may include an intermetallic compound.

The inclusion of the intermetallic compound may further enhance electrical connectivity with the first electrode layer. The intermetallic compound functions to connect a plurality of second conductive metal particles, thereby enhancing electrical connectivity, and may also surround and connect a plurality of second conductive metal particles.

In this case, the intermetallic compound may include a metal with a melting point lower than a curing temperature of the resin. That is, since the intermetallic compound includes a metal having a melting point lower than the curing temperature of the resin, the metal having a melting point lower than the curing temperature of the resin melts during a drying and curing process, forms an intermetallic compound with a portion of the metal particles, and surrounds the metal particles. At this time, the intermetallic compound may preferably include a low-melting-point metal of 300° C. or lower. More specifically, for example, the intermetallic compound may include tin (Sn) having a melting point of 213 to 220° C. During the drying and curing process, tin (Sn) melts, and the molten tin (Sn) wets high-melting-point metal particles, such as silver (Ag), nickel (Ni), or copper (Cu), by a capillary phenomenon, and reacts with a portion of the silver (Ag), nickel (Ni), or copper (Cu) metal particles to form intermetallic compounds, such as Ag₃Sn, Ni₃Sn₄, Cu₆Sn₅, Cu₃Sn, or the like. Silver (Ag), nickel (Ni), or copper (Cu) not participating in the reaction may remain in the form of metal particles.

Therefore, the plurality of second conductive metal particles may include at least one of silver (Ag), nickel (Ni), and copper (Cu), and the intermetallic compound may include one or more of Ag₃Sn, Ni₃Sn₄, Cu₆Sn₅, and Cu₃Sn.

The multilayer electronic component 100 may include the protective layer 150 disposed on at least one of the body 110 and the external electrodes 131 and 132.

The protective layer 150 may serve to improve electrical insulation, mechanical strength, thermal stability, or moisture resistance. For example, the protective layer 150 may include, but is not limited to, an epoxy resin.

The protective layer 150 may be disposed between the body 110 and the metal frames 201 and 202 described below or between the external electrodes 131 and 132 and the metal frames 201 and 202. The protective layer 150 may also be disposed on the body 110 or the external electrodes 131 and 132 in which the metal frames 201 and 202 are not disposed or may further be disposed even on the metal frames 201 and 202. That is, the protective layer 150 may be disposed on at least one of the body 110 and the external electrodes 131 and 132, or the protective layer 150 may be disposed to surround at least one of the body 110 and the external electrodes 131 and 132.

The size of the multilayer electronic component 100 need not be particularly limited.

Meanwhile, to maintain high reliability in a high-voltage environment, the effects of the present disclosure may be more noticeable in the multilayer electronic component 100 having the size 3225 (length×width: 3.2 mm×2.5 mm, with a length and width tolerance of +10%) or larger.

However, the present disclosure is not particularly limited thereto, and the width of the multilayer electronic component 100 may be greater than the length.

The composite electronic component 10 according to an exemplary embodiment of the present disclosure may include the metal frames 201 and 202 disposed on the external electrodes 131 and 132 and non-conductive adhesives 301 and 302 disposed between the external electrodes 131 and 132 and the metal frames 201 and 202.

The metal frames 201 and 202 may connect (including electrical connection) the multilayer electronic component 100 to an external circuit (such as a PCB), may serve as a buffer to prevent external stresses, such as bending or vibration of the substrate, from being transmitted to the multilayer electronic component 100, and may also alleviate thermal stress that may occur due to a difference in the coefficient of thermal expansion (CTE) between the substrate and the multilayer electronic component 100.

The metal frames 201 and 202 may include a multilayer structure and may include at least one layer including, for example, at least one of copper (Cu), nickel (Ni), palladium (Pd), and gold (Au).

The metal frames 201 and 202 may include sidewall portions 201-1 and 202-1 disposed on the connection portions 131-1 and 132-1 of the external electrodes and support portions 201-2, 202-2, 201-3, and 202-3 extending from the sidewall portions 201-1 and 202-1 and disposed on the band portions 131-2, 132-2, 131-3, and 132-3 of the external electrodes.

Meanwhile, the metal frames 201 and 202 may include a first metal f frame 201 disposed on the first external electrode 131 and a second metal frame 202 disposed on the second external electrode 132, and the first and second metal frames 201 and 202 may be spaced apart from each other.

More specifically, the first metal frame 201 may include a first sidewall portion 201-1 disposed on the first connection portion 131-1 and first support portions 201-2 and 201-3 extending from the first sidewall portion 201-1 and disposed on the first band portions 131-2 and 131-3, and the second metal frame 202 may include a second sidewall portion 202-1 disposed on the second connection portion 132-1 and second support portions 202-2 and 202-3 extending from the second sidewall portion 202-1 and disposed on the second band portion 132-2 and 132-3.

The first support portions 201-2 and 201-3 may include a 1-1-th support portion 201-2 extending from the first sidewall portion 201-1 and disposed on the 1-1-th band portion 131-2 and a 1-2-th support portion 201-3 extending from the first sidewall portion 201-1 and disposed on the 1-2-th band portion 131-3, and the second support portions 202-2 and 202-3 may include a 2-1-th support portion 202-2 extending from the second sidewall portion 202-1 and disposed on the 2-1-th band portion 132-2 and a 2-2-th support portion 202-3 extending from the second sidewall portion 202-2 and disposed on the 2-2-th band portion 132-3.

At this time, the 1-1-th and 2-1-th support portions 201-2 and 202-2 may be spaced apart from each other, and the 1-2-th and 2-2-th support portions 201-3 and 202-3 may also be spaced apart from each other.

In the present disclosure, unless otherwise specifically contradictory, the description of the metal frames 201 and 202 may refer to the description of the first metal frame 201 and the second metal frame 202, respectively. The description of the sidewalls 201-1 and 202-1 may refer to the description of the first sidewall 201-1 and the second sidewall 202-2, respectively, and the description of the support portions 201-2, 201-3, 202-2, and 202-3 may refer to the description of the 1-1-th support portion 201-2, the 1-2-th support portion 201-3, the 2-1-th support portion 202-2, and the 2-2-th support portion 202-3.

The non-conductive adhesives 301 and 302 may be disposed between the multilayer electronic component 100 and the metal frames 201 and 202.

The non-conductive adhesives 301 and 302 may include a first non-conductive adhesive 301 disposed between the multilayer electronic component 100 and the first metal frame 201 and a second non-conductive adhesive 302 disposed between the multilayer electronic component 100 and the second metal frame 202. The first and second non-conductive adhesives 301 and 302 may be spaced apart from each other.

The non-conductive adhesives 301 and 302 may serve to bond or connect the multilayer electronic component 100 and the metal frames 201 and 202.

The non-conductive adhesives 301 and 302 may be any non-conductive material with excellent adhesive properties. For example, the non-conductive adhesives may include at least one of an epoxy adhesive, a silicone adhesive, a polyurethane adhesive, an acrylic adhesive, and a thermoplastic adhesive, but are not particularly limited thereto. Meanwhile, the non-conductive adhesives 301 and 302 may preferably be non-conductive or substantially non-conductive and may not include or rarely include any conductive material.

The total content of the non-conductive adhesives 301 and 302 may be greater than 0.6 mg and less than 0.9 mg.

In the present disclosure, the total content of the non-conductive adhesives 301 and 302 may refer to the sum of the content of the first non-conductive adhesive 301 and the content of the second non-conductive adhesive 302. The content of the first non-conductive adhesive 301 and the content of the second non-conductive adhesive 302 may have an error of +10% based on the average of the content of the first non-conductive adhesive 301 and the content of the second non-conductive adhesive 302. That is, the content of each of the first non-conductive adhesive 301 and the second non-conductive adhesive 302 may preferably be greater than 0.3 mg and less than 0.45 mg.

By satisfying the total content of the non-conductive adhesives 301 and 302 to be greater than 0.6 mg and less than 0.9 mg, a substrate mounting rate may be excellent and acoustic noise may be effectively reduced.

If the total content of the non-conductive adhesives 301 and 302 is 0.6 mg or less, the substrate mounting rate may be reduced or acoustic noise may not be reduced, and if the total content of the non-conductive adhesives 301 and 302 is 0.9 mg or more, the substrate mounting rate may not be reduced, but the elasticity of the non-conductive adhesives 301 and 302 may be reduced, resulting in increased acoustic noise.

Methods for measuring the content of non-conductive adhesives 301 and 302 may be as follows, but are not particularly limited thereto.

First, n a composite electronic component including a metal frame, polishing is performed from a thickness and widthwise end-surface of a sidewall portion of the metal frame until a main bonding portion of the non-conductive adhesive is exposed. When the sidewall portion is removed and the main bonding portion is exposed, a volume may be obtained by measuring the area of the main bonding portion and the lengthwise size of the main bonding portion. The area of the region in which the main bonding portion is located is then subjected to EDS analysis using equipment, such as a SEM, TEM, or STEM, to conduct component analysis and/or content analysis. By applying the measured component analysis and/or content analysis values to the previously measured volume of the main bonding portion, the content of the main bonding portion may be calculated. Furthermore, the content of a sub-bonding portion may be calculated in the same manner, and the content of the non-conductive adhesive may be calculated by adding the contents of the main bonding portion and sub-bonding portion. If there are a plurality of metal frames, for example, two, it will be apparent to those skilled in the art that the same method may be applied to other metal frames to determine the content of other non-conductive adhesives.

More specifically, the metal frames 201 and 202 may be disposed on the connection portions 131-1 and 132-1 and the band portions 131-2 and 132-2 disposed on the first surface 1, with the non-conductive adhesives 301 and 302 interposed therebetween. Here, the band portions 131-2 and 132-2 disposed on the first surface 1 may refer to the 1-1-th band portion 131-2 and the 2-1-th band portion 132-2.

In the present disclosure, the non-conductive adhesives 301 and 302 are not limited to being in contact with the connection portions 131-1 and 132-1 and the metal frames 201 and 202 and the band portions 131-2 and 132-2 disposed on the first surface 1 and the metal frames 201 and 202 at the same time, and another component, for example, the protective layer 150, may be disposed therebetween.

That is, the non-conductive adhesives 301 and 302 may include main adhesive portions 301-1 and 302-1 disposed between the connection portions 131-1 and 132-1 and the metal frames 201 and 202 and sub-adhesive portions 301-2 and 302-2 disposed between the band portions 131-2 and 132-2 disposed on the first surface 1 and the metal frames 201 and 202. The total content of the aforementioned non-conductive adhesives 301 and 302 may refer to the sum of the content of the main adhesive portions 301-1 and 302-1 and the content of the sub-adhesive portions 301-2 and 302-2.

The main adhesive portions 301-1 and 302-1 and the sub-adhesive portions 301-2 and 302-2 may be disposed to be connected, thereby further improving the adhesive strength between the multilayer electronic component 100 and the metal frames 201 and 202. However, the present disclosure is not particularly limited thereto, and the main adhesive portions 301-1 and 302-1 and the sub-adhesive portions 301-2 and 302-2 may be disposed to be spaced apart from each other.

The first non-conductive adhesive 301 may include a first main adhesive portion 301-1 disposed between the first connection portion 131-1 and the first sidewall portion 201-1 and a first sub-adhesive portion 301-2 disposed between the 1-1-th band portion 131-2 and the 1-1-th support portion 201-2, and the second non-conductive adhesive 302 may include a second main adhesive portion 302-1 disposed between the second connection portion 132-1 and the second sidewall portion 202-1 and a second sub-adhesive portion 302-2 disposed between the 2-1-th band portion 132-2 and the 2-1-th support portion 202-2.

The thicknesses of the non-conductive adhesives 301 and 302 may be substantially constant.

Here, “thickness of the non-conductive adhesives 301 and 302” may not refer to only the size in the thickness direction. The thickness of the main adhesive portions 301-1 and 302-2 may correspond to the size in the length direction, and the thickness of the sub-adhesive portions 301-2 and 302-2 may correspond to the size in the thickness direction. Furthermore, “substantially constant thickness” may mean that an error is +10% with respect to an average value of the minimum and maximum thicknesses.

Since the thickness of the non-conductive adhesives 301 and 302 is substantially constant, delamination between the multilayer electronic component 100 and the metal frames 201 and 202 may be prevented, thereby improving the mounting rate of the composite electronic component 10.

As described above, the protective layer 150 may be disposed between the body 110 and the metal frames 201 and 202 or between the external electrodes 131 and 132 and the metal frames 201 and 202, may also be disposed on the body 110 or the external electrodes 131 and 132 on which the metal frames 201 and 202 are not disposed, and further, may also be disposed on the metal frames 201 and 202. That is, the protective layer 150 may be disposed on at least one of the body 110 and the external electrodes 131 and 132, or the protective layer 150 may be disposed to surround at least one of the body 110 and the external electrodes 131 and 132.

The protective layer 150 may be disposed between the non-conductive adhesives 301 and 302 and the metal frames 201 and 202.

More specifically, the protective layer 150 may be disposed between the first external electrode 131 and the first non-conductive adhesive 301 and between the second external electrode 132 and the second non-conductive adhesive 302. More specifically, the protective layer 150 may be disposed between the first connection portion 131-1 and the first main adhesive portion 301-1, between the 1-1-th band portion 131-2 and the first sub-adhesive portion 301-2, between the second connection portion 132-1 and the second main adhesive portion 302-1, and between the 2-1-th band portion 132-2 and the second sub-adhesive portion 302-2.

Meanwhile, the protective layer 150 may be disposed on the metal frames 201 and 202, and more specifically, may be disposed on the 1-2-th and 2-2-th support portions 201-3 and 202-3 in the thickness direction. That is, at least a portion of the 1-2-th and 2-2-th support portions 201-3 and 202-3 may have a structure drawn into the protective layer 150 or interposed between the protective layers 150.

The composite electronic component 10 may include conductive materials 401 and 402 disposed between the external electrodes 131 and 132 and the metal frames 201 and 202.

The conductive materials 401 and 402 may serve to connect (including electrical connection) the external electrodes 131 and 132 to the metal frames 201 and 202 and to enhance bonding strength. The conductive materials 401 and 402 may be any material with excellent conductivity. The conductive materials may include, but are not limited to, for example, an epoxy resin including at least one of silver (Ag) and copper (Cu).

The conductive materials 401 and 402 may include a first conductive material 401 disposed between the first external electrode 131 and the first metal frame 201 to connect the first external electrode 131 and the first metal frame 201 and a second conductive material 402 disposed between the second external electrode 132 and the second metal frame 202 to connect the second external electrode 132 and the second metal frame 202.

More specifically, the first conductive material 401 may be disposed between the 1-2-th band portion 131-3 and the 1-2-th support portion 201-3 to connect the 1-2-th band portion 131-3 and the 1-2-th support portion 201-3, and the second conductive material 402 may be disposed between the 2-2-th band portion 132-3 and the 2-2-th support portion 202-3 to connect the 2-2-th band portion 132-3 and the 2-2-th support portion 202-3.

In the present disclosure, unless otherwise specifically contradictory, the description of the conductive materials 401 and 402 may correspond to the description of the first conductive material 401 and the second conductive material 402, respectively.

Hereinafter, the present disclosure is described in more detail through experimental examples, which is intended to help understanding of the disclosure and are not intended to limit the scope of the present disclosure.

### Test Example

[Table 1] below illustrates a mounting defect rate according to the presence or absence of a non-conductive adhesive.

Comparative Example 1 corresponds to 100 sample chips including a body including a dielectric layer and internal electrodes, two external electrodes disposed on the body, a protective layer disposed on the body and the external electrodes, and a protective layer disposed on the external electrodes, which were manufactured but without a non-conductive adhesive between the external electrodes and a metal frame.

In Example 1, 100 sample chips manufactured in the same manner as those of Comparative Example 1, except that a total of 0.6 mg to 0.9 mg of epoxy adhesive, which is a non-conductive adhesive, was formed between the external electrodes and the metal frame. The non-conductive adhesive was formed to include both a main adhesive portion and a sub-adhesive portion.

The mounting defect rate is the number of mounting defective chips per 100 sample chips. The method for determining mounting defects was as follows: After mounting the sample chips of Comparative Example 1 and Example 1 on different PCB substrates, the capacitance, dissipation factor (DF), and equivalent series resistance (ESR) were measured. Sample chips that were measurable were evaluated as normal, and sample chips were not measurable were evaluated as mounting defects. The number of mounting defects was counted and recorded in [Table 1].

TABLE 1

| Test Example | Mounting defects (piece) |
|---|---|
| Comparative Example 1 | 3/100 |
| Example 1 | 0/100 |

Comparative Example 1 had 3/100 mounting defects, while Example 1 had 0/100. This demonstrates that mounting characteristics are improved when the non-conductive adhesive is formed with an appropriate content.

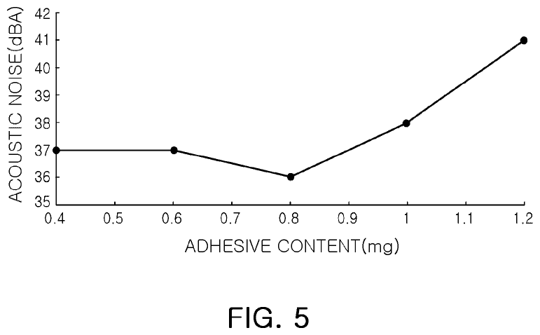

Next, FIG. 5 is a graph of acoustic noise (dBA) measured according to adhesive content (mg) (representing total content).

Acoustic noise was measured using noise measurement equipment after mounting sample chips based on adhesive contents onto different PCB substrates and applying solder.

When the adhesive content was 0.6 mg or less, acoustic noise reduction was minimal. However, when the adhesive content was greater than 0.6 mg and less than 0.9 mg, acoustic noise was reduced. However, when the adhesive content was 0.9 mg or more, acoustic noise increased.

From this, it can be seen that, when the adhesive is formed at an appropriate content greater than 0.6 mg and less than 0.9 mg, an acoustic noise reduction effect is achieved.

One of the various effects of the present disclosure is the excellent substrate mounting performance of the composite electronic component.

One of the various effects of the present disclosure is the reduction of acoustic noise in the composite electronic component.

One of the various effects of the present disclosure is the improvement of moisture resistance reliability in the composite electronic component.

However, the various advantages and effects of the present disclosure are not limited to the above-described contents and will be more readily understood through the description of specific exemplary embodiments of the present disclosure.

Although the exemplary embodiments or experimental examples of the present disclosure have been described in detail above, the present disclosure is not limited to the exemplary embodiments described above and the accompanying drawings, but is intended to be limited by the appended claims. Accordingly, various forms of substitution, modification, and change may be made by those skilled in the art within the scope without departing from the technical idea of the present disclosure described in the claims, and this will also be considered to fall within the scope of the present disclosure.

The expression “an exemplary embodiment or an example” used in the present disclosure does not refer to identical examples and is provided to stress different unique features between each of the examples. However, examples provided in the following description are not excluded from being associated with features of other examples and implemented thereafter. For example, even if matters described in a specific example are not described in a different example thereto, the matters may be understood as being related to the other example, unless otherwise mentioned in descriptions thereof.

The terms used herein are for the purpose of describing particular exemplary embodiments only and are not intended to limit the example exemplary embodiments. As used herein, the singular forms “a,” “an,” and “the” are intended to include the plural forms as well, unless the context clearly indicates otherwise.

What is claimed is:

1. A composite electronic component comprising:
a multilayer electronic component including a body including a dielectric internal electrodes alternately arranged with the dielectric layer in a thickness direction and including first and second surfaces opposing each other in the thickness direction, third and fourth surfaces connected to the first and second surfaces and opposing each other in a length direction, and fifth and sixth surfaces connected to the first to fourth surfaces and opposing each other in a width direction and an external electrode including a connection portion disposed on the third and fourth surfaces and a band portion extending from the connection portion to portions of the first and second surfaces;
a metal frame disposed on the external electrode; and
a non-conductive adhesive disposed between the external electrode and the metal frame,
wherein a total content of the non-conductive adhesive is greater than 0.6 mg and less than 0.9 mg.

2. The composite electronic component of claim 1, wherein the metal frame is disposed on the connection portion and the band portion disposed on the first surface, with the non-conductive adhesive interposed therebetween.

3. The composite electronic component of claim 1, wherein the multilayer electronic component further includes a protective layer disposed on at least one of the body or the external electrode.

4. The composite electronic component of claim 3, wherein the protective layer is disposed between the metal frame and at least one of the body or the external electrode.

5. The composite electronic component of claim 3, wherein the protective layer is disposed on the metal frame.

6. The composite electronic component of claim 1, further comprising a conductive material disposed between the external electrode and the metal frame.

7. The composite electronic component of claim 6, wherein the metal frame is disposed on the band portion that is disposed on the second surface, with the conductive material interposed therebetween.

8. The composite electronic component of claim 1, wherein an average length of the multilayer electronic component is 3.2 mm or greater and an average width of the multilayer electronic component is 2.5 mm or greater.

9. A composite electronic component comprising:
a multilayer electronic component including a body including a dielectric layer and internal electrodes alternately arranged with the dielectric layer in a thickness direction and including first and second surfaces opposing each other in the thickness direction, third and fourth surfaces connected to the first and second surfaces and opposing each other in a length direction, and fifth and sixth surfaces connected to the first to fourth surfaces and opposing each other in a width direction, an external electrode including a connection portion disposed on the third and fourth surfaces and a band portion extending from the connection portion to portions of the first and second surfaces, and a protective layer disposed on at least one of the body or the external electrode;
a metal frame disposed on the external electrode; and
a non-conductive adhesive disposed between the external electrode and the metal frame,
wherein the metal frame is disposed on the connection portion and the band portion disposed on the first surface, with the non-conductive adhesive interposed therebetween.

10. The composite electronic component of claim 9, wherein a total content of the non-conductive adhesive is greater than 0.6 mg and less than 0.9 mg.

11. The composite electronic component of claim 9, wherein the protective layer is disposed between the metal frame and at least one of the body or the external electrode.

12. The composite electronic component of claim 9, wherein the protective layer is disposed on the metal frame.

13. The composite electronic component of claim 9, further comprising a conductive material disposed between the external electrode and the metal frame.

14. The composite electronic component of claim 13, wherein the metal frame is disposed on the band portion that is disposed on the second surface, with the conductive material interposed therebetween.

15. The composite electronic component of claim 9, wherein an average length of the multilayer electronic component is 3.2 mm or greater and an average width of the multilayer electronic component is 2.5 mm or greater.

16. The composite electronic component of claim 9, wherein the non-conductive adhesive includes a main adhesive portion disposed between the connection portion of the external electrode and the metal frame, and a sub-adhesive portion disposed between the band portion of the external electrode and the metal frame.
